(19) United States
(12) Patent Application Publication
(10) Pub. No.: US 2010/0058086 A1
(43) Pub. Date: Mar. 4, 2010

(54) ENERGY-EFFICIENT MULTI-CORE PROCESSOR

(75) Inventor: Wan Yeon LEE, Chuncheon-si (KR)

Correspondence Address: INTELLECTUAL PROPERTY LAW GROUP LLP, 12 SOUTH FIRST STREET, SUITE 1205, SAN JOSE, CA, 95113, US

(73) Assignee: INDUSTRY ACADEMIC COOPERATION FOUNDATION, HALLYM UNIVERSITY, Gangwon-do (KR)

(21) Appl. No.: 12/200,698

(22) Filed: Aug. 28, 2008

(51) Int. Cl. G06F 1/00

(52) U.S. Cl. 713/322

(57) ABSTRACT

Energy-efficient multi-core processor systems are provided. A multi-core processor may include a plurality of processor cores configured to process a task in parallel and at least one of a lowest voltage level and a lowest clock frequency among available voltage levels and clock frequencies is chosen to enable the selected processor cores to complete a task within a task deadline.

### BACKGROUND

In recent years, there is an increasing use of portable, mobile devices (such as cellular phones, laptops, personal digital assistants, portable multimedia players, etc.) having a significant impact on people's lifestyles and behaviors. The immense popularity of such mobile devices has led to considerable efforts in developing technologies capable of operating central processing units (CPUS) in an energy efficient fashion. With limited battery life in mobile computing environments, such technologies will allow for improved capability and productivity of various mobile devices.

Conventional techniques for saving power consumption include dynamic power management (DPM) and dynamic voltage scaling (DVS). FIG. 1A shows a typical example of an inefficient operation of a processor, where a task T₁ is completed at a time tₑ, while power or operational clock is still being supplied to the processor even after time tₑ, until a task deadline t_{d}. In DPM, a processor is periodically monitored to check if any task is being performed by the processor. If it turns out that the processor is not performing any task (i.e., in an “idle” state), the processor is powered off to save unnecessary power consumption. As depicted in FIG. 1B, the supply of power or operational clock is halted upon reaching time tₑ after completing the task to stop unnecessary power consumption during the idle period (between tₑ and t_{d}).

Another conventional technique for saving power consumption is DVS, which relates to changing voltage levels or clock frequencies supplied to a processor based on the processing load. In general, DVS enables a processor to perform a given task at a speed proportional to the supplied voltage or clock frequency, while the processor consumes more power as the supplied voltage or clock frequency increases FIG. 1C illustrates that power consumption of a processor can be reduced in accordance with DVS-based techniques by halving the voltage or clock frequency supplied if task T₁ can be completed within task deadline t_{d}.

However, it should be noted that the above-explained DPM and DVS power management schemes are mainly tailored for “single-core” processor systems. With increasing and widespread use of multi (or multi-core) processor systems, there is a need for developing efficient power management schemes that can be implemented for more complex multi-core processor architectures.

### SUMMARY

Various embodiments of systems and corresponding methods for reducing power consumption in a multiprocessor environment are provided. In one embodiment by way of non-limiting example, a multi-core processor includes a plurality of processor cores configured to process a task in parallel and a controller configured to provide at least one of a voltage level and a clock frequency to the plurality of processor cores. In this embodiment, a certain number of the processor cores may be selected to execute the task. Unselected processor cores, for example, may be placed in an unselected state, and at least one of a lowest voltage level and a lowest clock frequency among available voltage levels and clock frequencies may be chosen to enable the selected processor cores to complete the task within a task deadline.

The Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1A is a PRIOR ART figure showing a schematic graph illustrating a relationship between power consumption and voltage level/clock frequency in a single-core processor environment without using any power saving schemes.

FIG. 1B is a PRIOR ART figure showing a schematic graph illustrating a relationship between power consumption and voltage level/clock frequency when DPM is applied in a single-core processor environment.

FIG. 1C is a PRIOR ART figure showing a schematic graph illustrating a relationship between power consumption and voltage level/clock frequency when DVS is applied in a single processor core environment.

FIG. 2 shows an illustrative embodiment of a block diagram of a multi-core processor system environment supporting DVS capability.

FIG. 3 shows an illustrative embodiment of a graph showing relationships between power consumption and voltage level of two exemplary processor cores.

FIG. 4 shows an illustrative embodiment of a graph showing relationships between task completion speed (i.e., speedup) and processor core numbers in parallel completion of a task for four different speedup models.

FIG. 5 shows schematic diagrams of an illustrative embodiment of power-saving schemes in a multi-core environment.

FIG. 6 is a flow chart of an illustrative embodiment of a method for determining voltage level and/or clock frequency to reduce power consumption for completing a task in accordance with a “loose scheduling” scheme.

FIG. 7 is a flow chart of an illustrative embodiment of a method for returning a lowest voltage or frequency to complete the task with n processor cores within a given execution deadline in accordance with the loose scheduling scheme.

FIG. 8 is a flow chart of an illustrative embodiment of a method for utilizing a pair of voltage levels and/or clock frequencies to facilitate minimization of power consumption for completing a task in accordance with a “tight scheduling scheme.

FIG. 9 is a flow chart of an illustrative embodiment of a method for returning the pair of voltage levels and/or clock frequencies to complete the task with n processor cores by a given execution deadline in accordance with the tight scheduling scheme.

FIG. 10 shows an illustrative embodiment of a graph showing example energy consumption ratios in an Intel® XScale® processor when the loose scheduling and the tight scheduling are applied with different workloads.

FIG. 11 shows an illustrative embodiment of a graph showing example energy consumption ratios in a IBM® PPC405LP® processor when the loose scheduling and the tight scheduling are applied with different workloads.

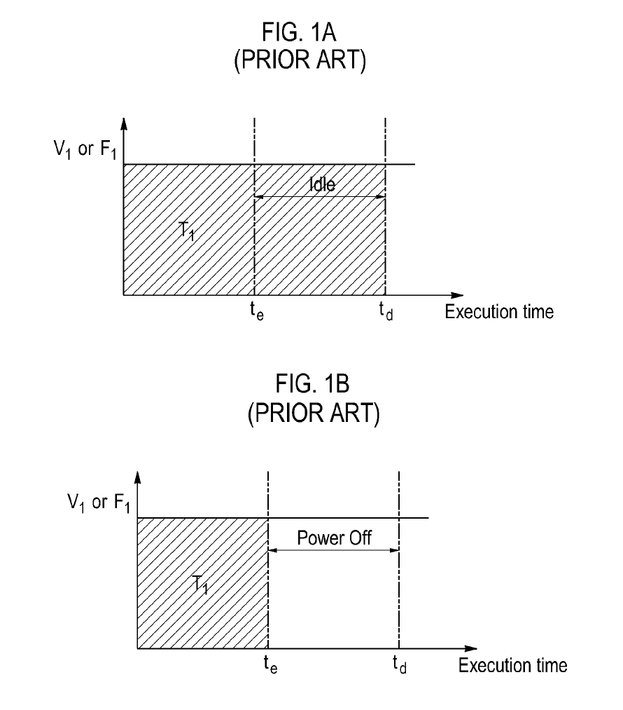

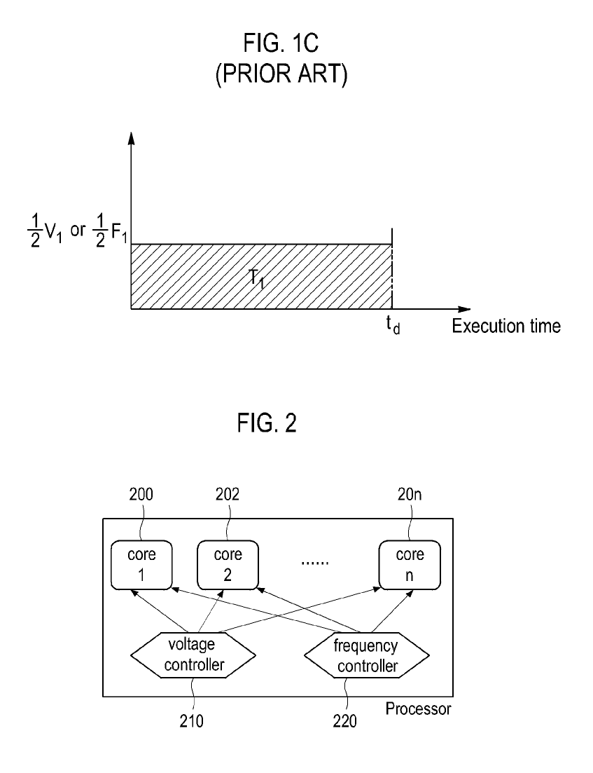

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure, as generally described herein, and illustrated in the Figures, may be arranged, substituted, combined, and designed in a wide variety of different configurations, all of which are explicitly contemplated and make part of this disclosure.

FIG. 2 shows an illustrative embodiment of a multi-core processor environment where one or more embodiments of the present disclosure can be implemented. As depicted in FIG. 2, for example, the multi-core processor environment may include n processor cores 200, 202 . . . 20n. In some embodiments, each processor core is provided with the same level of voltage and/or the same clock frequency. The same voltage or frequency, for example, may be continuously provided until a task deadline. A voltage level and/or clock frequency may be selected from a group of available voltage levels and/or clock frequencies that may be supplied to processor cores 200, 202 . . . 20n. A voltage controller 210, for example, may select one voltage level from the available voltage levels to provide the selected voltage level to each processor core. Likewise, a frequency controller 220, for example, may select one clock frequency from the available clock frequencies to provide the selected frequency to each processor core. In one example, voltage controller 210 and frequency controller 220 may take into account an execution deadline for a given task, the number of cores involved in task execution, a relationship between power consumption and voltage level for a core, a relationship between task completion speed and the number of cores involved in task completion, and the like in choosing an appropriate voltage level and/or frequency.

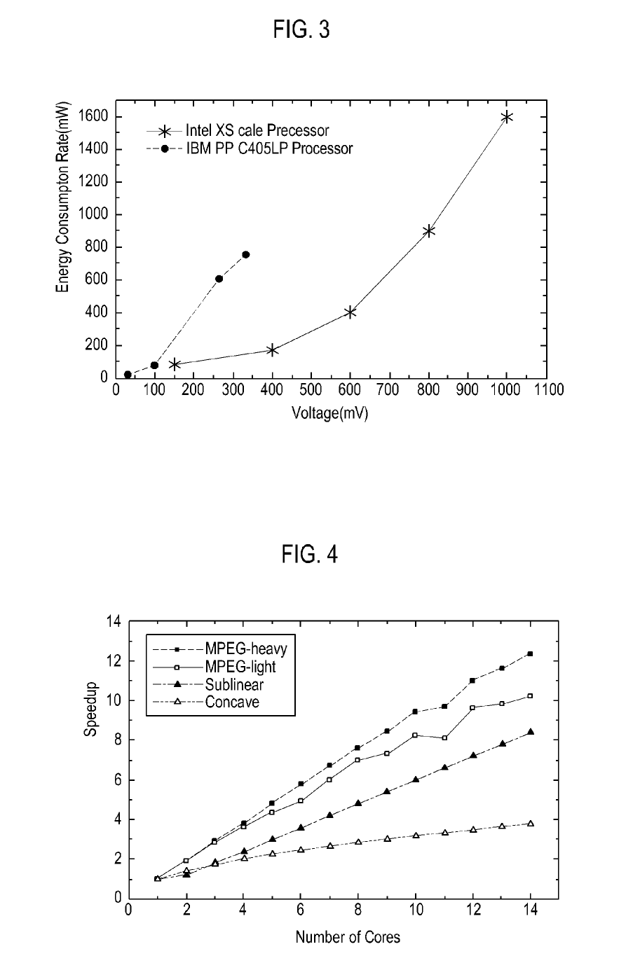

Referring to FIG. 3, two well-known multi-core processors are examined to illustrate correlations between clock frequency and power consumption per processor core. Intel XScale® and IBM® PPC 405LP® are known for having multiple process cores capable of DVS. When DVS is applied, available voltage levels or clock frequencies are not continuous but discrete. For example, an Intel® XScale® processor may be provided with five clock frequencies, ranging from 150 MHz to 1000 MHz as shown in FIG. 3, and for an IBM® PPC405LP® processor, four frequencies (namely, 33, 100, 266, and 333 MHz) as its clock frequencies. For each available clock frequency, for example, FIG. 3 shows power consumption rates per processor core for a computation cycle. It should be noted that IBM® PPC 405LP® has a concave up shape (i.e., relationship) between power consumption and frequency from 33 MHz to 266 MHz, while it has a concave down shape from 100 MHz to 333 MHz.

In the following, the relationship between the number of processor cores involved in task execution and speedup for task execution will be explained. By way of example, but not limitation, a given task may be directed to a video data compressed by a compression scheme such as Moving Picture Expert-2 (MPEG-2) or H.264 scheme. In general, these compression schemes use a series of image frames, each of which varies in required computation. In one example, to code or decode each video frame, each processor core can finish a necessary task faster as a clock frequency provided to the core increases. In other words, the time to complete a given task may be determined by dividing the necessary computation cycles by a supplied clock frequency. However, the given task, for example, should be completed by a certain time limit called a “task deadline.” For example, National Television Standard Committee (NTSC) Digital Versatile Disc (DVD)) quality MPEG-2 video should be retrieved at approximately 30 or 24 frames per second, resulting in task deadlines of about 33.3 ms or 41.7 ms, respectively. As the task deadlines may be different with various kinds of tasks, the required computational cycles may also vary. Examples of computations relating to video may include decomposition of video pictures, motion predictions, and disjoint partitions of each image picture in coarse grained implementation and fine grained implementation. In a multi-core processor environment, for example, the required computations can be performed by multiple cores in parallel, and the speedup of computation may depend on the task characteristics.

By way of illustration, but not limitation, four speedup models depending on task characteristics are shown in FIG. 4. The first two speedup models are drawn from experimental data generated from parallel MPEG-2 video task execution on a Silicon Graphics Challenge® multiprocessor with a share memory. In one example, the first model labeled as MPEG-heavy is a video coding/decoding task with a 1408×960 resolution, and the second model labeled as MPEG-light is a video coding/decoding task with a 352×240 resolution.

As shown in FIG. 4, for example, these two models have approximately linear relationships between the number of parallel processing-involved cores and the speedup of task execution. In one example, the other two speedup models labeled as sublinear and concave were synthesized to take into account the overhead of parallel execution. The overhead of parallel execution, for example, may include, unbalanced subtask distribution and additional processing required for distributing subtasks, communication and synchronization in calculating the speedup of task execution with an increase in the number of processor cores involved in task execution.

The sublinear model shown in FIG. 4 represents a speedup model where the speedup of task execution is proportional to the number of cores allocated to the divided task. In this illustrative embodiment, the overhead of parallel processing is assumed to be 40% of the total computational burden. That is, if n-cores are involved in parallel processing of a task, the speedup of the task completion would be 0.6×n, wherein n>1.

The last model as shown in FIG. 4, for example, is the concave model. The concave model, for example, illustrates how the speedup of task completion can be proportional to the square root of the number of cores involved in parallel processing of a task, as shown in FIG. 4.

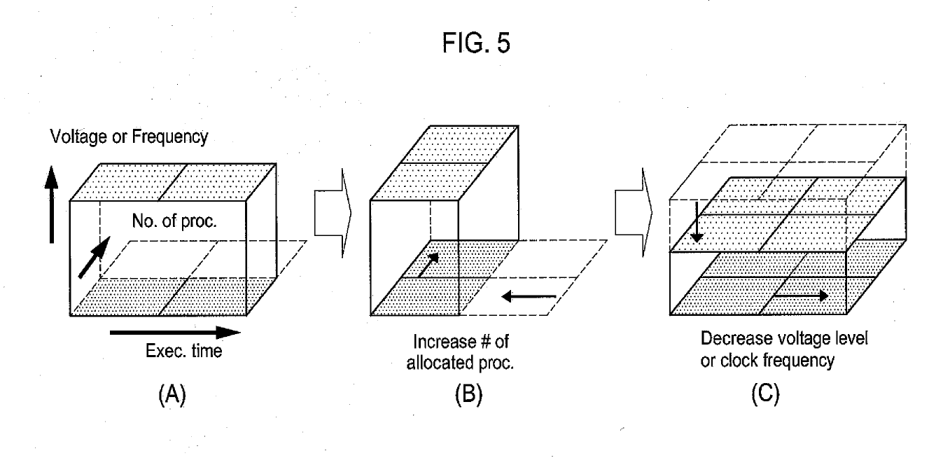

FIG. 5 shows schematic diagrams of an illustrative embodiment of power saving schemes. As depicted in FIG. 5, for example, the X, Y, and Z-axes indicate the execution time, number of allocated process cores, and supplied voltages or frequencies, respectively. FIG. 5(A) illustrates a situation where a task is not divided, and it is allocated to a plurality of process cores, but is performed by one process core only. It should be noted that a relatively high voltage level or clock frequency needs to be supplied to the active process core in order to complete the task within its deadline. FIG. 5(B) illustrates the advantages of parallel processing wherein the task may be divided and allocated to a plurality of n processor cores.

In one example, as depicted in FIG. 5(B), since multiple process cores execute necessary computations in parallel to complete the entire task, the task can be completed in less time. Such fast task completion resulting from parallel processing, for example, can allow for lowering of voltage level or clock frequency supplied to the allocated cores. In one example, FIG. 5(C) illustrates that a lower voltage level or clock frequency can be selected so long as the task is completed within the given task deadline. In sum, the more processor cores that are involved in the task execution, for example, the shorter the time to complete the task.

Furthermore, a shorter completion time, for example, may result in lowering of voltage level or clock frequency supplied to the cores, which in turn may reduce the amount of power consumption needed for completing the task. In the following, it will be demonstrated by example mathematical expressions that the combination of numerous process cores (involved in task execution) and lowering of voltage level or clock frequency may reduce the overall power consumption necessary for task completion.

By way of example, but not limitation, the execution speed of a processor core may be linearly proportional to the voltage level or clock frequency, as expressed in the following example equation (1):

Execution Speed∝(Voltage Level)¹ or (Clock Frequency)¹ (1)

In addition, the power consumption of each core may increases in an exponential manner with voltage level or clock frequency as expressed in the following example equation (2):

Power consumption of Core∝(Voltage Level)^{X} or (Clock Frequency)^{X} (2)

wherein X is not smaller than 2. In a multi-core environment, for example, a given task can be divided and assigned to multiple cores so that each core does not need to execute the assigned task as fast as when only a single core performs the entire task. Thus, a voltage level or clock frequency supplied to the assigned cores can be reduced, and in turn, for example the lowering of voltage level or clock frequency may result in a reduction of power consumption at an exponential rate. For example, as shown in FIG. 5(B), when a task is divided and assigned to two cores, the task can be completed twice as fast as a single core with the same voltage level or clock frequency. If the voltage level or clock frequency supplied to the two cores is reduced by half, for example, the task can be completed in the same amount of time with the single core since the execution speed of a core is linearly proportional to voltage level or clock frequency. The lowering of voltage level or clock frequency, for example, can reduce power consumption of a core by (½)^{X}. If X is assumed to be 2, for example, each core consumes one fourth of the power used by a single core to complete the task. Since two cores are involved in completing the task, the total energy consumed by the two cores may be reduced by half. It should be noted that the foregoing illustrative example may be derived under several assumptions, for example, an exponential function between power consumption and voltage level or clock frequency, continuity of available voltage levels or clock frequencies, and ignorance on an overhead caused by parallel processing.

In practice, the above assumptions may not be plausible. As explained above, multi-core processors do not appear to show an explicit relationship between power consumption and supplied voltage level or clock frequency. Moreover, voltage levels or clock frequencies that can be supplied to a multi-core processor may not be continuous but may be discrete. Also, parallel processing may be accompanied by an overhead.

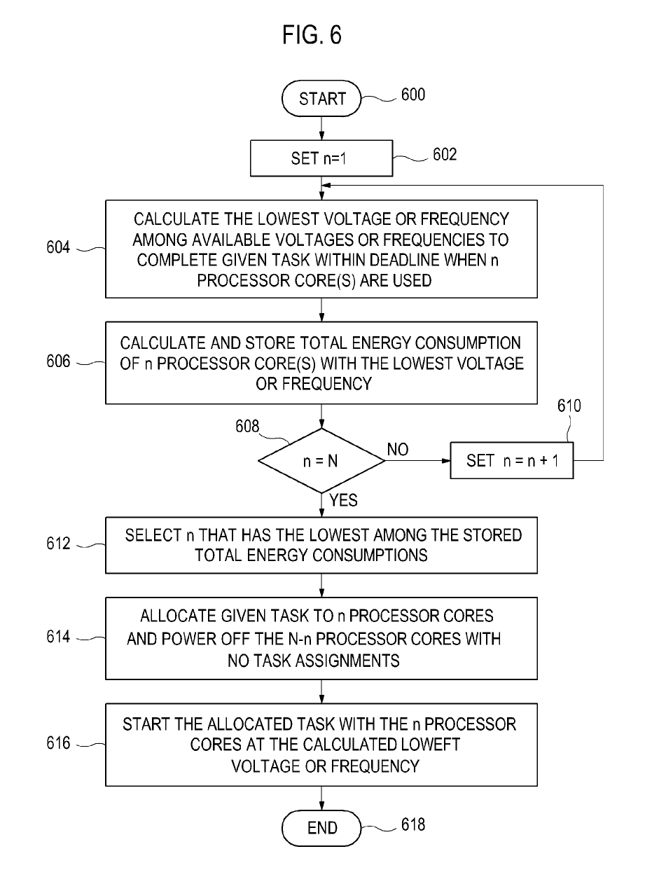

In one embodiment, a scheme called “loose scheduling” is provided. Loose scheduling, for example, assumes that the number of processor cores involved in executing a task and the voltage level or clock frequency would be fixed (not changed) throughout completion of the task. By way of example, but not limitation, FIG. 6 is a flow chart of an illustrative embodiment of the loose scheduling scheme. Starting from block 600, for example, the loose scheduling initializes n as 1 at block 602. At block 604, for example, the lowest voltage level or clock frequency that allows n processor core(s) to complete a given task within a deadline is calculated. At block 606, for example, the total power consumption to complete the task is calculated when the n processor core(s) are involved in executing the task. The calculated power consumption is also stored in association with the n processor cores. At block 608, it is determined whether n has reached N, for example, represents the number of cores provided in a multi-core processor environment. If n reaches N, for example, the loose scheduling proceeds to block 612. Otherwise, for example, the loose scheduling advances to block 610, where n is increased by one, and then, returns to block 604. As shown in FIG. 6, blocks 604 through 608 are repeated until n reaches N. In one embodiment, when the loose scheduling proceeds to block 612, for each n of the processor cores, the lowest voltage level or clock frequency and the total power consumption of the n processor cores to complete the task within the task deadline have been stored. At block 612, for example, the n is selected to have the lowest power consumption to complete the task. The loose scheduling, for example, assigns the given task to the n processor cores and turns off the N-n “unassigned” or “unselected” processor cores at block 614. In one example, for the allocated task, the n processor cores start executing the task, for example, and the calculated voltage level or clock frequency may be supplied to each of the n processor cores as the loose scheduling processes at block 616. Finally, the loose scheduling ends at block 618. Under the loose scheduling scheme, for example, changing voltage level or clock frequency supplied to the assigned n cores is not allowed.

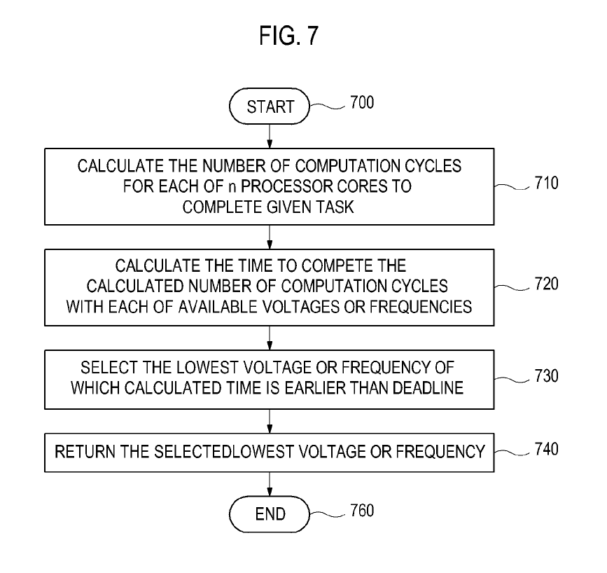

FIG. 7 is a flow chart of an illustrative embodiment for performing block 604 of the loose scheduling shown in FIG. 6, wherein among the available voltages or frequencies for processor cores, the lowest voltage or frequency is calculated to complete the task within the deadline when the n processor cores are assigned to the task. Starting from block 700, at block 710, for example, the number of computation cycles for each of the n processor cores to complete the given task by parallel processing is calculated. In one embodiment, for this calculation, the relation between the number of processor cores involved in the task and a speedup for the task completion may be taken into account since this relation may affect the amount of time for completing the task. As explained earlier, for example, the so-called MPEG-heavy model depicted in FIG. 4 indicates a linear relationship between the number of parallel processing involved cores and the speedup of task execution, while the so-called concave model shows that the speedup of task completion is proportional to the square root of the number of cores involved in parallel processing of a task. After the number of computation cycles is fixed, at block 720, for example, the method may calculate the time to perform the fixed number of computation cycles when the n processor cores involved in the parallel processing of the task are supplied with one of the available voltage levels or clock frequencies. For each of all the available voltage levels or clock frequencies, the time to perform the fixed number of computation cycles will be calculated. At block 730, for example, the method may select the lowest of voltage levels or clock frequencies that can allow the n processor cores to perform the number of computation cycles necessary to complete the task within the task deadline. The selected lowest voltage level or clock frequency, for example, may be returned at block 740 to the loose scheduling before the method ends at block 760.

The following example pseudocode describes the loose scheduling method wherein a given task requires C* cycles to be performed, and D represents the deadline for the task. It is also assumed that when n processor cores execute the task in parallel, the task execution can be expedited by s(n) depending on the characteristics of the task or the multi-core processor system. In one example, e(fₘ) means the power consumption per cycle when frequency fₘ is supplied to the processor cores. The example pseudocode can be provided on a computer readable medium.

Eₘᵢₙ ← ∞;
for each n from n = 1 to n = N

| { | select the smallest frequency f_{m′} satisfying ${f}_{{m}^{′}} \geq ⌈ \frac{{C}^{*}}{s ( n )} ⌉ \cdot \frac{1}{D} ;$ | |
|---|---|---|
| | if ( e(f_{m′}) · D · f_{m′} · n < Eₘᵢₙ ) | |
| | { | n* ← n; m* ← m′; Eₘᵢₙ ← e(f_{m′}) · D · F_{m′} · n; } |

}
allocate n* cores and turn off the power of the other cores;
assign the frequency f_{m*} to execute $⌈ \frac{{C}^{*}}{s ( {n}^{*} )} ⌉ cycles ;$

In loose scheduling, for example, there may exist a slack time when the task is completed in advance of the deadline. During the slack time, the n processor cores, having completed the task, for example, may continue to consume power even if there is no task left for the cores while voltage or frequency continues to be provided until the task deadline. To reduce unnecessary power consumption during such slack time, as another embodiment, a scheme called “tight schedule” is provided. In the tight schedule scheme, for example, further power saving can be achieved by utilizing a pair of voltage levels or clock frequencies. For example, in the tight schedule scheme, a pair of voltage levels or clock frequencies may be utilized to facilitate minimization of power consumption for the n processor cores to help facilitate completion of the task within the task deadline by allowing a single transition between the pair of voltage levels or clock frequencies while parallel processing of the task. For example, one part of the task will be executed by supplying one voltage level or clock frequency, and the other part of the task will be executed by another lower voltage level or clock frequency supplied.

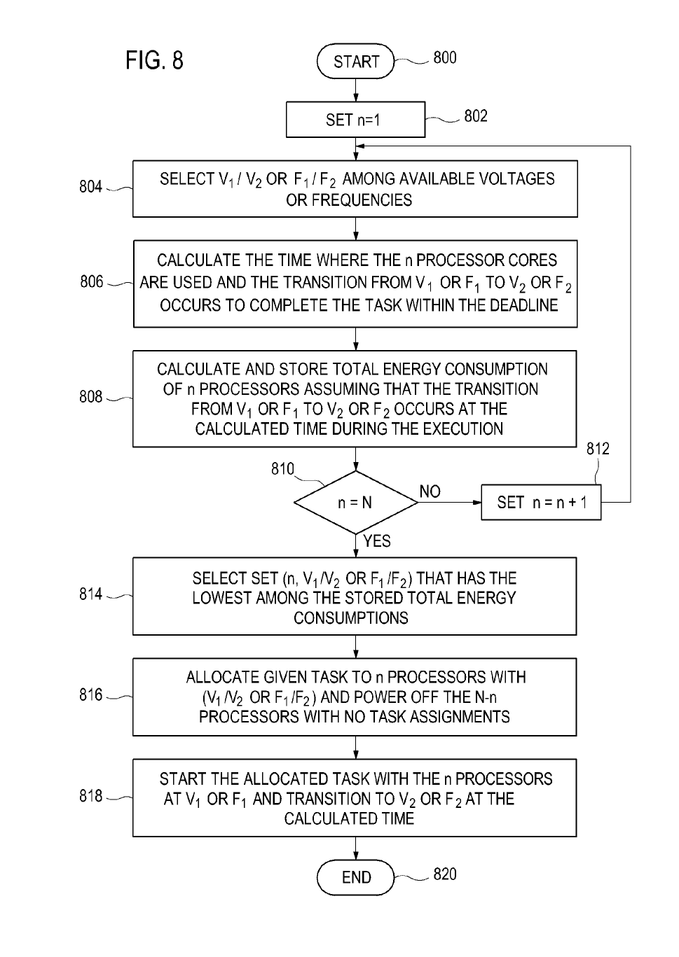

By way of example, not limitation, FIG. 8 is a flow chart of an illustrative embodiment of the tight scheduling scheme. After starting at block 800, for example, the tight scheduling initializes n as 1 at block 802. The tight scheduling proceeds to block 804, for example, to select a pair of voltage levels (V₁, V₂) or a pair of clock frequencies (F₁, F₂) among the available voltage levels or clock frequencies. At block 806, for example, the tight schedule will calculate the time when the transition from V1 to V2 or from F1 to F2 occurs to complete the task within the task deadline under the assumption that the n processor cores are used to complete the task. The task may be completed up to and including the deadline, or exactly at the deadline. At block 808, for example, the total power consumption for the n processor core(s) to complete the task is calculated when the transition from V1 to V2 or from F1 to F2 occurs at the calculated transition time. In one example, the calculated total power consumption is also stored in association with the n processor cores and the pair of the voltage levels or the clock frequencies. At block 810, for example, it is determined whether n reaches N. N, for example, represents the number of cores provided in a multi-core processor environment If n reaches N, for example, the tight scheduling proceeds to block 814. Otherwise, for example, the tight scheduling advances to block 812, where n is incremented by one, and then, returns to block 804. As illustrated in FIG. 8, for example, blocks 804 and 810 are repeated until n reaches N. When proceeding to block 814, the tight scheduling may compare energy consumption information stored and calculated each time the tight scheduling proceeds to Block 808. The tight scheduling does this comparison by assuming that the task completed by each n processor cores with a transition from V1 to V2 or from F1 to F2 occurs at the calculated transition time. At block 814, for example, as a result of comparison, a combination set of the number n of processor cores to be used and a pair of voltage levels or clock frequencies is selected to have the lowest power consumption. The tight scheduling, for example, assigns the given task to the n processor cores together with the pair of voltage levels or clock frequencies and turns off the N-n unassigned processor cores at block 816. In one example, for the allocated task, the n processors start executing the task and the voltage level V1 or clock frequency F1 is supplied to each of the n processor cores as the tight scheduling proceeds to block 818. At the calculated transition time, for example, the voltage level or clock frequency is switched from V₁ or F₁ to V₂ or F₂. Finally, for example, the tight scheduling ends at block 820. Under the tight scheduling, it should be noted that the change in voltage level or clock frequency supplied to the assigned n cores, for example, occurs during task execution.

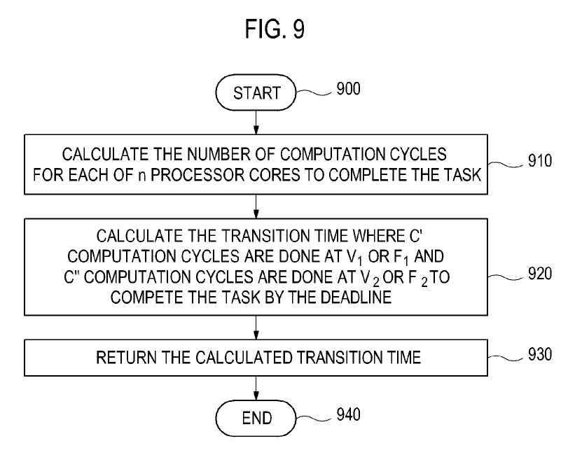

FIG. 9 is a flow chart of an illustrative embodiment for performing block 806 of the tight scheduling shown in FIG. 8, wherein the time when the transition from V₁ to V₂ or from F₁ to F₂ occurs is determined under the constraint that the n processor cores should complete the task within the task deadline. Starting at block 900, at block 910, for example, the number of computation cycles for each of the n processor cores to complete the given task in parallel is calculated. In one example, for this calculation, as explained above, the relation between the number of processor cores involved in the task and a speedup for the task completion by parallel processing, such as MPEG-heavy, MPEG-light, sublinear, or concave model may be taken into account. After the number of computation cycles is fixed, at block 920, for example, the method will calculate the time to transition voltage level or clock frequency supplied to the n processor cores from V₁ or F₁ to V₂ or F₂. In one embodiment, for this calculation, it is assumed that C′ computation cycles are performed by supplying V₁ or F₁ to the processor cores, and C″ computation cycles are performed by supplying V₂ or F₂ wherein C′ plus C″ is equal to the calculated number of computational cycles for the n processor cores to complete the task by the deadline. The calculated transition time, for example, may be returned at block 930 to the tight scheduling before the method ends at block 940.

The following example pseudocode describes the tight scheduling scheme wherein a given task requires C* cycles to be done, and D represents the deadline for the task. The pseudocode for the tight scheduling can be provided on a computer readable medium.

Eₘᵢₙ ← ∞;
for each n from n = 1 to n = N

| { | select the smallest frequency f_{m′} satisfying ${f}_{{m}^{′}} \geq ⌈ \frac{{C}^{*}}{s ( n )} ⌉ \cdot \frac{1}{D} ;$ | |
|---|---|---|
| | if ( e(f_{m′}) · D · f_{m′} · n < Eₘᵢₙ ) | |
| | { | ${C}_{1} ← ⌈ \frac{{C}^{*}}{s ( n )} ⌉ ;$ C₂ ← 0; n* ← n; m* ← m′; Eₘᵢₙ ← e(f_{m′}) · D · f_{m′} · n; } |
| | $if ( {f}_{{m}^{′}} > ⌈ \frac{{C}^{*}}{s ( n )} ⌉ \cdot \frac{1}{D} and {m}^{′} < M )$ | |
| | { | ${C}^{′} ← ⌈ \frac{{f}_{{m}^{′}} ( ⌈ \frac{{C}^{*}}{s ( n )} ⌉ - D \cdot {f}_{{m}^{′} + 1} )}{{f}_{{m}^{′}} - {f}_{{m}^{′} + 1}} ⌉ ; {C}^{n} ← ⌊ \frac{{f}_{{m}^{′} + 1} \cdot ( D \cdot {f}_{{m}^{′}} - ⌈ \frac{{C}^{*}}{s ( n )} ⌉ )}{{f}_{{m}^{′}} - {f}_{{m}^{′} + 1}} ⌋ ;$ |

| if ( (e(f_{m′}) · C′ + e(f_{m′+1}) · C″) · n < Eₘᵢₙ ) | |
|---|---|
| { | C₁ ← C′; C₂ ← C″; Eₘᵢₙ ← (e(f_{m′}) · C′ + e(f_{m′+1}) · |
| | C″) · n; } |

| | |
|---|---|
| } | } |

allocate n* cores and turn off the power of the other cores;
assign frequency fₘ* to execute C₁ cycles and frequency fₘ8₊₁ to execute C₂ cycles;

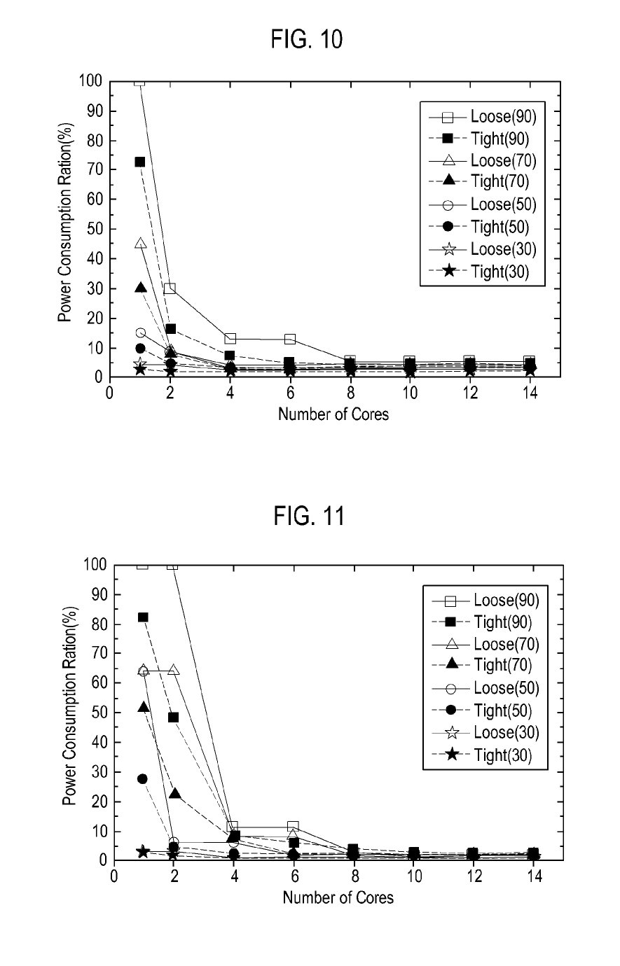

FIGS. 10 and 11 show simulation results for power savings in accordance with the loose scheduling and the tight scheduling schemes provided in this disclosure. Both of the simulations assume that the task to be executed by a multi-core processor follows the MPEG-heavy model. The simulation of FIG. 10 used an Intel® XScale® processor, and the simulation of FIG. 11 used an IBM® PPC 405LP® processor. In addition, for the simulations, the workload is defined to be the ratio of the time for a single core to complete a task using the highest voltage level or clock frequency to a time deadline. The workload is indicated in each parenthesis in the legend of FIGS. 10 and 11. In order to quantitatively compare the power consumption of processor cores following the method of this disclosure to that of a single core, Power Consumption Ratio PCR) is defined as the ratio of power consumption of multi-core execution implementing the method of this disclosure to that of single core execution with the highest voltage level or clock frequency.

As shown in FIG. 10, for example, when an Intel® XScale® processor is used, the loose and tight scheduling of this disclosure can save power consumption for completing a task. For example, FIG. 10 shows that the power saving method of this disclosure can achieve less than about 5% PCR when the loose or tight scheduling is utilized to complete the task by using more than 8 processor cores for all work loads. It is noted, for example, that when using more than 6 processor cores, the loose and tight schedulings offer no significant differences in power consumption

In the simulation of FIG. 11, an IBM® PPC405LP® processor is used. As the number of processor cores involved in executing a task is over 4, for example, the power consumption is less than 10% of that using a single core with the highest voltage level or clock frequency. It is also noted that when the number of processor cores used to complete the task is over 8 in the simulation of FIG. 11, for example, the tight scheduling does not show a significant improvement in power consumption compared to the loose scheduling.

In light of this disclosure, those skilled in the art will appreciate that the apparatus, and methods described herein may be implemented in hardware, software, firmware, middleware, or combinations thereof and utilized in systems, subsystems, components, or sub-components thereof. For example, a method implemented in software may include computer code to perform the operations of the method. This computer code may be stored in a machine-readable medium, such as a processor-readable medium or a computer program product, or transmitted as a computer data signal embodied in a carrier wave, or a signal modulated by a carrier, over a transmission medium or communication link (e.g., a fiber optic cable, a waveguide, a wired communication link or a wireless communication link). The machine-readable medium or processor-readable medium may include any medium capable of storing or transferring information in a form readable and executable by a machine (e.g., by a processor, a multi-core processor, a computer, etc.). Types of machine-readable mediums may include but are not limited to, a floppy disk, a hard disk drive, a Compact Disc (CD), a Digital Video Disk (DVD), a digital tape, a computer memory, etc.

From the foregoing, it will be appreciated that various embodiments of the present disclosure have been described herein for put-poses of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A multi-core processor comprising:
a plurality of processor cores configured to process a task in parallel; and
a controller configured to provide at least one of a voltage level and a clock frequency to the plurality of processor cores,
wherein a certain number of the processor cores are selected to execute the task, thereby placing unselected processor cores in an unselected state, and
at least one of a lowest voltage level and a lowest clock frequency among available voltage levels and clock frequencies is chosen to enable the selected processor cores to complete the task within a task deadline.

2. The multi-core processor of claim 1, wherein the available voltage levels and clock frequencies comprise the available voltage levels and clock frequencies as definite and discrete.

3. The multi-core processor of claim 1, wherein the unselected processor cores in the unselected state comprise the unselected state to include the unselected processor cores turned off.

4. The multi-core processor of claim 1 further comprising
a pair of voltage levels from the available voltage levels being utilized to facilitate minimization of power consumption for the selected processor cores to help facilitate completion of the task within the task deadline when one of the pair of voltage levels is supplied during an execution time, and the other voltage level is supplied during a remaining period of the execution time.

5. The multi-core processor of claim 1 further comprising
a pair of clock frequencies from the available clock frequencies being utilized to facilitate minimization of power consumption for the selected processor cores to help facilitate completion of the task within the task deadline when one of the pair of the clock frequencies is supplied during an execution time, and the other clock frequency is supplied during the remaining period of the execution time.

6. The multi-core processor of claim 4, wherein the available voltage levels comprise the available voltage levels as definite and discrete.

7. The multi-core processor of claim 5, wherein the available clock frequencies comprise the available clock frequencies as definite and discrete.

8. The multi-core processor of claim 6, wherein the unselected processor cores in the unselected state comprise the unselected state to include the unselected processor cores turned off.

9. The multi-core processor of claim 4, wherein the pair of voltage levels has at least one of a linear relationship and a concave up relationship between power consumption and voltage level increase.

10. The multi-core processor of claim 5, wherein the pair of clock frequencies has at least one of a linear relationship and a concave up relationship between power consumption and frequency increase.

11. A system comprising:
a processor having a plurality of processor cores; and
a controller configured to provide at least one of a voltage level and a clock frequency to the plurality of processor cores,
wherein a certain number of the processor cores are selected to execute a task in parallel, thereby placing unselected processor cores in an unselected state, and
at least one of a lowest voltage level and a lowest clock frequency among available voltage levels and clock frequencies is chosen to enable the selected processor cores to complete the task within a task deadline.

12. The system of claim 11, wherein the available voltage levels and clock frequencies comprise the available voltage levels and clock frequencies as definite and discrete.

13. The system of claim 11, wherein the unselected processor cores in the unselected state comprise the unselected state to include the unselected processor cores turned off.

14. The system of claim 12, wherein the unselected processor cores in the unselected state comprise the unselected state to include the unselected processor cores turned off.

15. A power saving method for use in a multi-core process environment comprising:
selecting a certain number of processor cores configured to execute a task in parallel, thereby placing unselected processor cores in an unselected state; and
selecting among available voltage levels and clock frequencies at least one of a lowest voltage level and a lowest clock frequency to enable the selected processor cores to complete the task within a task deadline.

16. The power saving method of claim 15, wherein the unselected processor cores in the unselected state comprise the unselected state to include the unselected processor cores turned off.

17. A machine-readable medium having stored thereon instructions, which when executed by a machine, cause the machine to implement a power saving method for use in a multi-core processor environment, the method comprising:
selecting a certain number of processor cores configured to execute a task in parallel, thereby placing unselected processor cores in an unselected state; and
choosing among available voltage levels and clock frequencies at least one of a lowest voltage level and a lowest clock frequency to enable the selected processor cores to complete the task within a task deadline.

18. The machine-readable storage medium of claim 17, wherein the available voltage levels and clock frequencies comprises the available voltage levels and clock frequencies as definite and discrete.

19. The machine-readable storage medium of claim 17, wherein the unselected processor cores in the unselected state comprise the unselected state to include the unselected processor cores turned off.
